(19) United States
(12) Patent Application Publication
(10) Pub. No.: US 2024/0116154 A1
(43) Pub. Date: Apr. 11, 2024

(54) Ratchet Wrench and External Ratchet Bushing Anti-Detachment Quick-Release Structure

(71) Applicant: Tai Fong Pneumatic Tools Co., Ltd., Taichung City (TW)

(72) Inventor: Fu-Yuan Chen, Taichung City (TW)

(21) Appl. No.: 18/172,568

(22) Filed: Feb. 22, 2023

(30) Foreign Application Priority Data
Oct. 7, 2022 (TW) 111138312
Oct. 7, 2022 (TW) 111211041

(51) Int. Cl. B25B 13/46; B25B 23/00

(52) U.S. Cl. CPC B25B 13/463; B25B 23/0057

(57) ABSTRACT

A ratchet wrench and an external ratchet bushing anti-detachment and quick-release structure have an anti-detachment and quick-release assembly, a ratchet wrench and an external component. The anti-detachment and quick-release assembly can be pushed up and down by displacement and is magnetic, a ratchet wheel is arranged in the actuating end of the ratchet wrench, and the anti-detachment and quick-release assembly is fixed on one side of the ratchet wheel. When the external component is placed in the ratchet, it can be fixed by the magnetic adsorption of the anti-detachment and quick-release assembly. When disassembling, the external component is pushed against the external component to disengage from the ratchet. When the ratchet wrench is subjected to external force, the components will not be disengaged and damaged, and the overall structural assembly stability is good, so as to gain structural stability and allow safety use.

### BACKGROUND OF THE INVENTION

Conventional quick release structure of a ratchet wrench is shown in FIG. 7, it includes a ratchet wrench 20 and a quick release device 30. The ratchet wrench 20 is provided with an actuating end 21, the actuating end 21 is provided with a ratchet 210, the ratchet 210 is fixed with a C-shaped buckle 211, the ratchet 210 is provided with a drive hole 210A, and the quick release device 30 is provided with a magnetic ring 31, a pressed part 32 and an outer cover 33. The magnetic ring 31 is fixed on the inner side of the driving hole 210A of the ratchet 210 near the top edge, the pressed part 32 can be vertically moved and adsorbed and clamped above the inner edge of the magnetic ring 31, and the outer cover 33 is set on the top of the pressed part 32. By placing an external component 40 such as a bushing or a screw lock in the driving hole 210A, the external component 40 is attracted by the magnetic ring 31 and pushes up the pressed part 32, and the top side of the pressed part 32 protrudes above the outer cover 33. When one wants to remove the external component 40, press the pressed part 32 protruding from the outer cover 33, so that the external component 40 is detached from the adsorption of the magnetic ring 31. Although it can achieve the quick release effect of the external fixation of the external component 40. However, according to the ratchet wrench usage habits, the operator may throw the ratchet wrench after use, and place the ratchet wrench on the tool platform. The quick release device 30 may be disengaged from the ratchet wrench 20, and further the magnetic ring 31 of the quick release device 30 may be formed. The structure is then broken and damaged. As such, it is necessary to improve it.

### SUMMARY OF THE INVENTION

In view of the poor structural stability and poor safety of use of the conventional ratchet wrench structure, the present invention completes the ratchet wrench and the external ratchet bushing anti-detachment and quick release structure of the present invention.

Accordingly, the present invention provides a ratchet wrench and an external ratchet bushing anti-detachment and quick-release structure, comprising: an anti-detachment quick-release assembly, the anti-detachment quick-release assembly is provided with a fixed ring body, a movable fitting seat body and a threaded fitting cover body, the fixed ring body is provided with a number of sliding through holes at intervals, a fixed hole is respectively provided between the sliding piercing holes on the bottom side of the fixed ring body, a magnetic column is fixedly embedded in the fixed hole, the sliding shaft seat part and a set of seat parts, the bottom side of the sliding shaft seat part is provided with several sliding shafts at intervals, an inner fitting space is provided in the body of the threaded fitting cover body, the top side of the threaded fitting cover body is provided with a positioning fit ring flange, the sliding shaft set on the sliding shaft seat of the moving fit seat is displaceable and slides through the sliding holes set in the fixed ring body, and the fitting space inside the cover body and positioning fitting ring flange are relatively positioned fitting to the fitting seat provided by the moving fitting seat; a ratchet wrench, wherein the ratchet wrench is provided with an actuating end, the actuating end is provided with a ratchet, and the ratchet is fixed with a C-shaped buckle, and the ratchet is provided with a driving hole, and the driving hole is provided with a ring near the top edge, the positioning and fixing part, the fixing ring body of the anti-detachment quick-release assembly is positioned and fixed on the ring positioning and fixing part of the ratchet wheel of the ratchet wrench; and an external component, the external component is accommodated in the driving hole of the ratchet provided on the working end of the ratchet wrench.

In a preferred embodiment, the anti-detachment quick release assembly has anti-slip embossing on the outer side of the wearing cover body, and the anti-slip embossing is arranged in straight, twill or cross patterns to increase the convenience of operation and use, so as to achieve the effect of good functionality.

In a preferred embodiment, the magnetic column embedded in the fixing hole of the fixing ring body of the anti-detachment quick release assembly is a strong magnetic column to provide stable magnetic attraction and achieve good functionality.

In a preferred embodiment, the external component is a ratchet bush or a screw lock, which enhances the diversity of operation and use, so as to achieve the effect of good functionality.

In a preferred embodiment, the thickness of the fixed ring body of the anti-detachment quick release assembly is A, and the length of the sliding shaft of the moving fitting seat is B, and the length B of the sliding shaft is greater than the thickness A of the fixing ring body, so that the moving fitting seat body The number of sliding shafts can slide vertically through the holes of the number of sliding relative to the fixed ring without falling off, so as to provide the stability of the action and achieve the effect of good functionality.

In a preferred embodiment, pressing the fitting seat part set on the moving fitting seat of the anti-detachment quick release assembly, so that the fitting seat part is displaced relative to the fitting space set in the fitting body, and at the same time make the sliding shaft seat of the moving fitting seat body The number of sliding shafts set at the bottom moves downward, passes through the number of sliding holes set in the fixed ring body, and pushes against the magnetic column of the external component away from the fixed hole set in the fixed ring body for magnetic adsorption, so that the external component is detached from the action of the ratchet wrench The driving hole of the ratchet on the end provides the convenience of quick disassembly and removal, so as to achieve the effect of good functionality.

In a preferred embodiment, with the cooperation of the anti-detachment quick release assembly, ratchet wrench and external components, the anti-detachment quick release assembly is provided with a fixed ring body, a movable fitting seat body and a threaded fitting cover body, and the moving fitting seat body is opposite to fixed ring body can be shifted up and down in the threaded cover body, and the fixed ring body is magnetic. There is a ratchet wheel inside the actuating end of the ratchet wrench. The anti-detachment quick release assembly is fixed on the side of the ratchet wheel. When the external component is placed into the ratchet, it can be fixed by the magnetic adsorption of the fixed ring body, and the moving seat can be pressed against the fixed ring body to push the external component into the ratchet, and it will not be detached and damaged under external force. Moreover, the overall structural assembly stability is good, and it can be disassembled and removed quickly and easily, so as to achieve the effect of good structural stability and safe use.

### BRIEF DESCRIPTION OF DRAWINGS

FIG. 1 is a three-dimensional combination state reference diagram of the ratchet wrench and the external ratchet bush anti-detachment and quick release structure of the present invention;

FIG. 2 is a three-dimensional disassembled state reference diagram of the anti-detachment and quick release structure of the ratchet wrench and the external ratchet bushing of the present invention;

FIG. 3 is a side view cross-sectional state reference diagram of the ratchet wrench and the external ratchet bush anti-detachment and quick release structure of the present invention;

FIG. 4 is a reference diagram of the operation state of the ratchet bushing of the ratchet wrench and the outer ratchet bushing anti-detachment and quick release structure of the ratchet wrench and the outer ratchet bushing of the present invention;

FIG. 5 is a side view section of the ratchet wrench and the external ratchet bush anti-detachment quick-release structure of the present invention. The reference diagram for the screw lock of the external assembly is assembled;

FIG. 6 is a reference diagram of the anti-slip embossing on the outer side of the cover body of the anti-slip and quick-release set of the embodiment of the anti-slip and quick-release structure of the ratchet wrench and the external ratchet bushing of the present invention; and

FIG. 7 is a reference diagram of the quick release structure section state of the conventional ratchet wrench with the anti-detachment quick release structure of the ratchet wrench and the external ratchet bushing of the present invention.

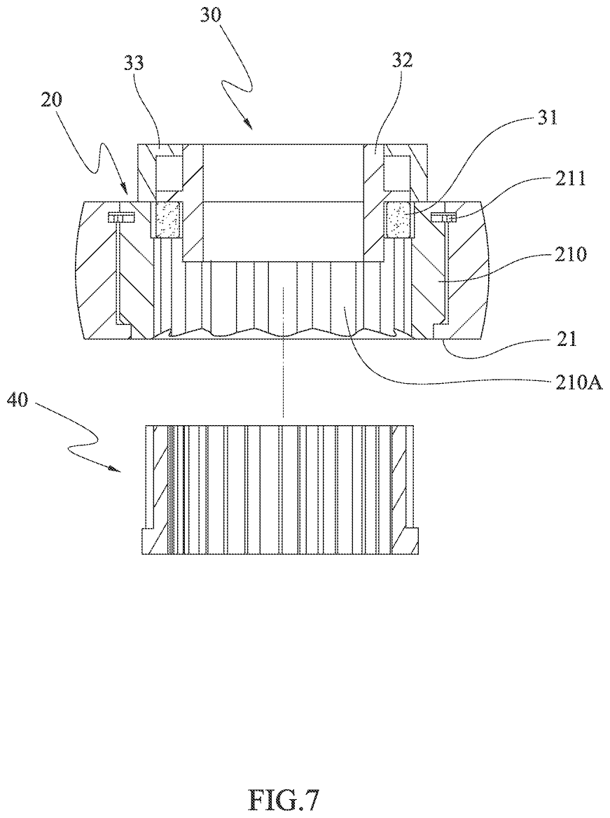

### DETAILED DESCRIPTION OF THE INVENTION

This invention relates to a ratchet wrench and an external ratchet bushing anti-detachment and quick-release structure and, more particularly, to a structure applied to the quick release of the external ratchet sleeve of the ratchet wrench and the prevention of force detachment.

Unless defined otherwise, all technical and scientific terms used herein have the same meanings as commonly understood by one of skill in the art to which this disclosure belongs. It will be further understood that terms; such as those defined in commonly used dictionaries, should be interpreted as having a meaning that is consistent with their meaning in the context of the relevant art and the present disclosure, and will not be interpreted in an idealized or overly formal sense unless expressly so defined herein.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

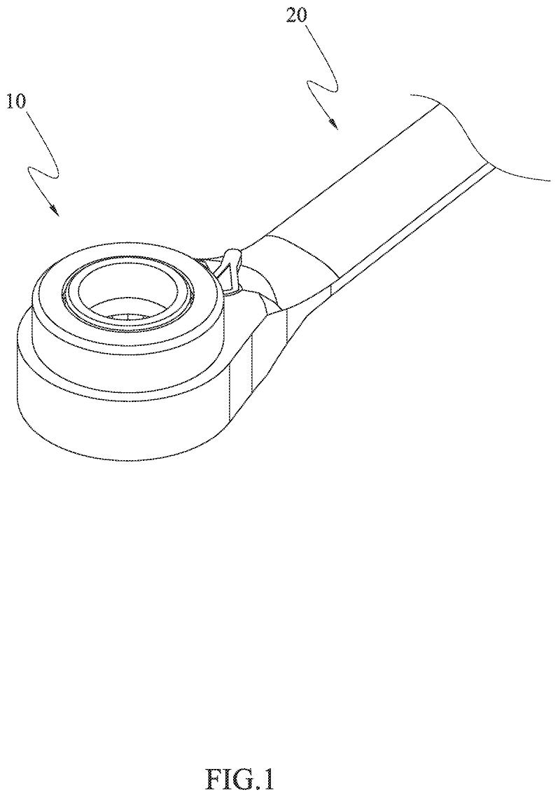

Reference is collectively made to FIGS. 1 to 4, which are the three-dimensional combined state, three-dimensional disassembled state, side view section state, and side view section assembled external assembly actuation state of the ratchet wrench and the external ratchet bushing anti-detachment quick release structure of the present invention. The structure of the present invention includes:

An anti-detachment quick-release assembly 10, the anti-detachment quick-release assembly 10 is provided with a fixed ring body 11, a movable fitting seat body 12 and a threaded fitting cover body 13, the fixed ring body 11 is provided with penetrating holes at intervals. There are several sliding piercing holes 110, the sliding piercing holes 110 on the bottom side of the fixed ring body 11 are respectively provided with a fixed hole 111, and a magnetic post 111A is fixedly embedded in the fixed hole 111, the moving sleeve body 12 is hollow, the moving fitting seat 12 is integrally provided with a sliding shaft seat 120 and a set of the fitting seat 121, and the bottom side of the sliding shaft seat 120 is provided with several sliding shafts 120A at intervals. The threaded fitting cover body 13 is provided with an inner fitting space 130, and the top side of the threaded fitting cover 13 is provided with a positioning fitting ring flange 131, and the sliding shaft seat 120 of the moving fitting seat 12 is provided with several sliding shafts. 120A, which is displaceable and slides through the number of sliding holes 110 provided in the fixed ring body 11. The fitting space 130 and the positioning fitting ring flange 131 in the fitting cover body 13 are fitted through the fittings and are positioned and fitted relative to each other. The fitting seat part 121 provided on the moving fitting seat body 12;

A ratchet wrench 20, the ratchet wrench 20 is provided with an actuating end 21, and the actuating end 21 is provided with a ratchet 210, and the ratchet 210 is fixed by a C-shaped buckle 211, and the ratchet 210 is provided with a driving hole 210A, the driving hole 210A is provided with an annular positioning and fixing part 210B near the top edge, and the fixing ring body 11 of the anti-detachment quick release assembly 10 is positioned and fixed on the ring positioning and fixing part 210B of the ratchet 210 of the ratchet wrench 20; and

An external component 40 is accommodated in the driving hole 210A of the ratchet 210 provided on the actuating end 21 of the ratchet wrench 20.

With the cooperation of the above structures, the ratchet wrench and the external ratchet bushing anti-detachment and quick release structure of the present invention are completed.

Referring to FIGS. 1 to 4, which are the three-dimensional combined state, three-dimensional disassembled state, side view section state, and side view section assembled external assembly actuation state of the ratchet wrench and the external ratchet bushing anti-detachment quick release structure of the present invention. The fixed ring body 11 of the anti-detachment and quick release assembly 10 is positioned and fixed on the ring positioning and fixing part 210B of the ratchet 210 of the ratchet wrench 20. In the driving hole 210A, simultaneously push against the sliding shaft 120A set on the sliding shaft seat 120 of the moving fitting seat 12, so that it moves upward relative to the sliding piercing hole 110 set on the fixed ring body 11. The fitting seat portion 121 of the seat body 12 is displaced in the inner fitting space 130 and is held against the flange 131 of the positioning fitting ring, and the external component 40 is fixed by the fixing ring body 11 of the anti-detachment quick release assembly 10. The magnetic column 111A of the hole 111 is magnetically adsorbed and fixed. Through the cooperation of the anti-detachment quick release assembly 10, the ratchet wrench 20 and the external component 40, the anti-detachment quick release assembly 10 is provided with a fixed ring body 11, a movable fitting seat body 12 and a threaded fitting cover body 13, and the movable fitting seat body 12 can be displaced up and down relative to the fixed ring body 11 and is set in the threaded fitting cover body 13, and the fixed ring body 11 is magnetic, and a ratchet 210 is provided in the actuating end 21 of the ratchet wrench 20. The anti-detachment quick release assembly 10 is fixed on one side of the ratchet 210, when the external component 40 is placed in the ratchet 210, it can be fixed by the magnetic adsorption of the fixed ring 11, and can move the fitting seat 12 relative to the fixed ring by pressing The body 11 acts to push the external component 40 and place it into the ratchet 210. Under the condition of external force, there will be no detachment damage, and the overall structural assembly stability is good, and it can be disassembled and removed quickly and easily to achieve structural stability and use safety.

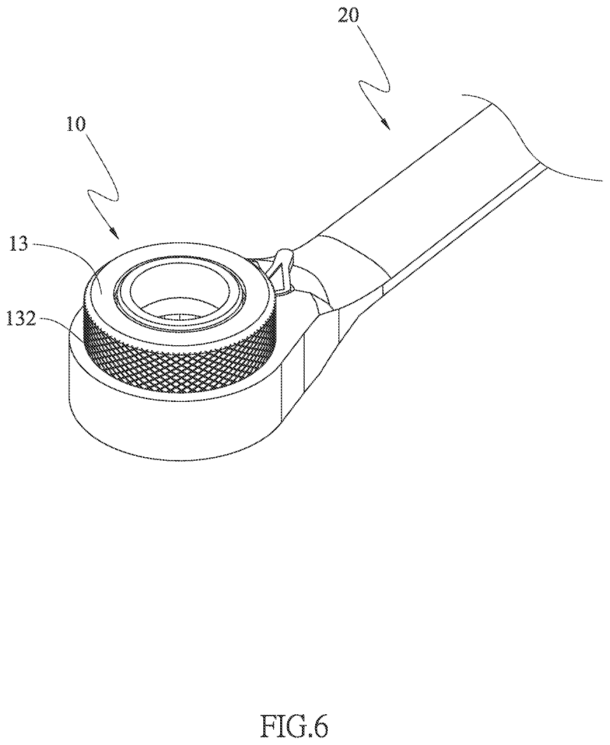

Reference is next made to FIG. 6, which is a reference diagram of the anti-detachment and quick-release structure of the embodiment of the anti-detachment and quick-release structure of the ratchet wrench and the external ratchet bushing of the present invention. In a preferred embodiment, the anti-detachment embossing 132 is provided on the outer surface of the threaded cover body 13 of the anti-detachment quick-release assembly 10, and the anti-detachment embossing 132 is arranged in straight, twill or cross patterns to increase the ease of operation, in order to achieve the effect of good functionality.

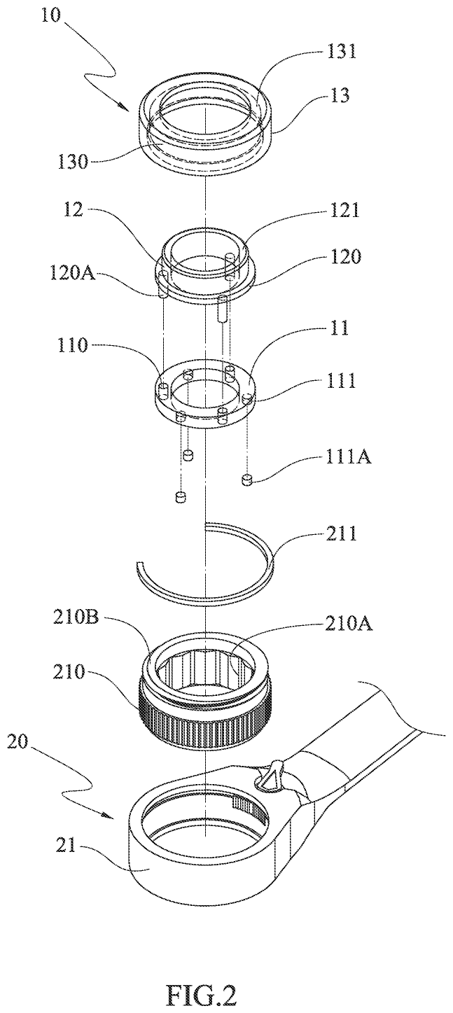

Referring to FIG. 2, which is a three-dimensional exploded state reference diagram of the anti-detachment and quick-release structure of the ratchet wrench and the external ratchet bushing of the present invention. In a preferred embodiment, the fixing of the anti-detachment and quick-release assembly 10. The magnetic column 111A embedded in the fixing hole 111 of the ring body 11 is a powerful magnetic column to provide stable magnetic attraction force and achieve good functionality.

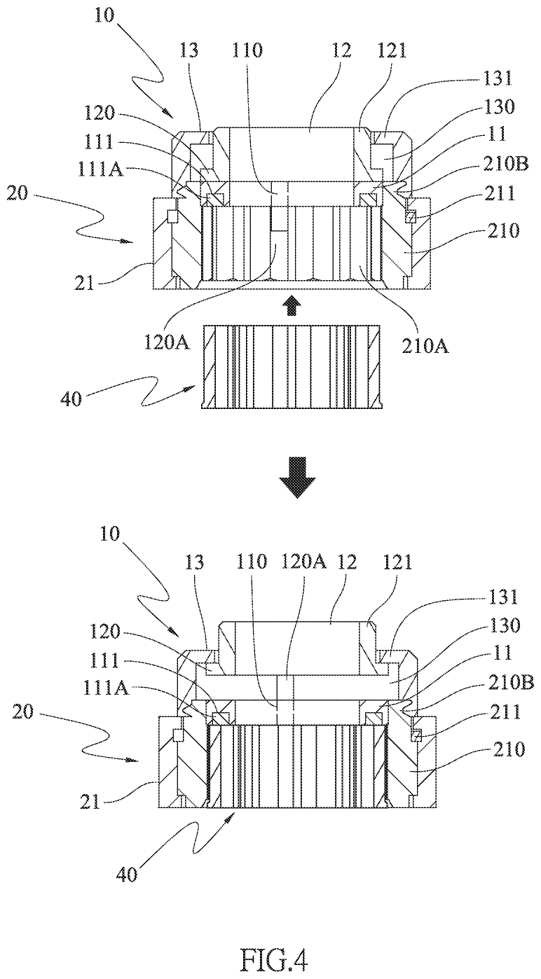

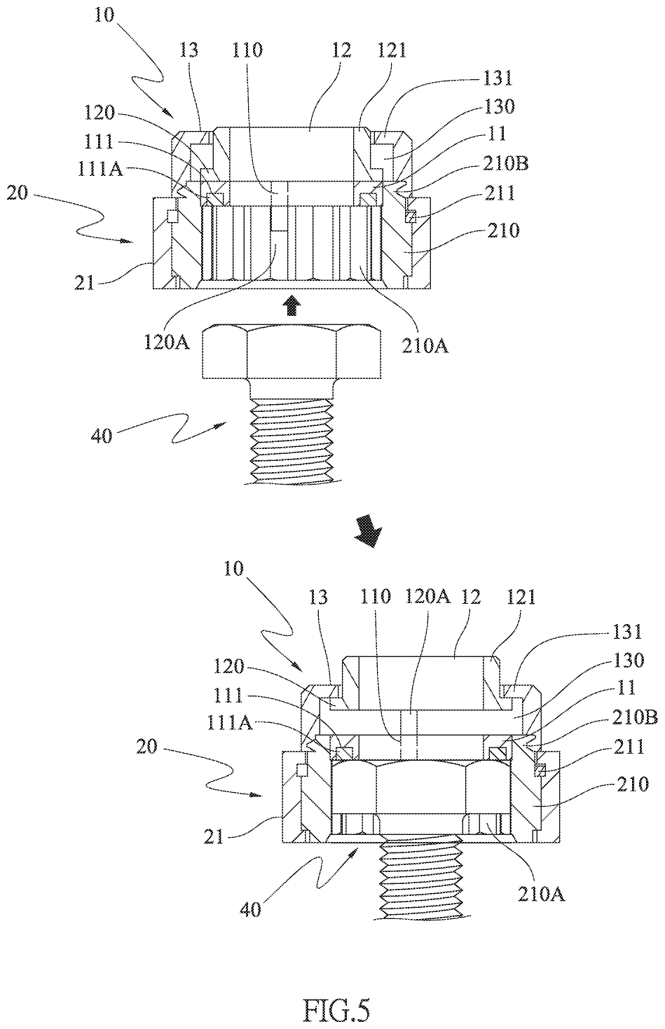

Referring to FIGS. 4 and 5, which are the actuation state of the ratchet bushing of the ratchet wrench and the external ratchet bush anti-detachment and quick release structure of the ratchet wrench and the external ratchet bushing inside view section assembly and the screw lock of the external assembly inside view section. Referring to the figures, in a preferred embodiment, the external component 40 is a ratchet bush or a screw lock, which enhances the diversity of operation and use to achieve the effect of good functionality.

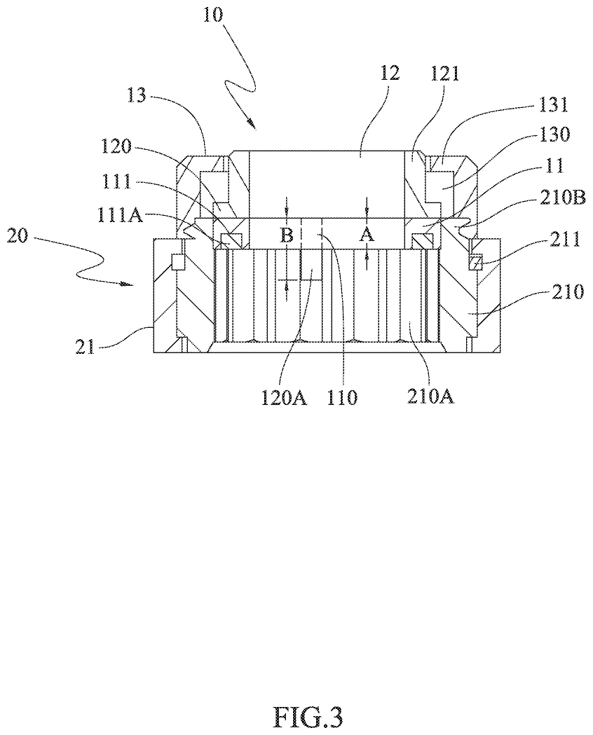

Referring to FIGS. 2 and 3, which are the three-dimensional decomposition state and side view section state reference diagram of the ratchet wrench and the external ratchet bushing anti-detachment quick release structure of the present invention. The thickness of the fixed ring body 11 of the detachment group 10 is A, the length of the sliding shaft 120A of the moving sleeve body 12 is B, and the length B of the sliding shaft 120A is greater than the thickness A of the fixed ring body 11, so that the moving sleeve The sliding shaft 120A of the seat body 12 can slide longitudinally through the sliding hole 110 set by the fixed ring body 11 without falling off, so as to provide stability of the action and achieve good functionality.

Reference is then made to FIGS. 2 to 5, which are the three-dimensional disassembled state of the ratchet wrench and the external ratchet bush anti-detachment and quick release structure of the present invention, the side view section state, the ratchet bush action state, and the side view of the side view section assembled external assembly. Referring to the figure for the operating state of the screw lock of the cross-sectional assembly of the external component. The fitting seat 121 is set on the moving fitting seat 12 of the pressing anti-detachment quick release assembly 10, so that the fitting seat 121 is opposite to the fitting cover 13. The set fitting space 130 is displaced, and at the same time, the sliding shaft 120A set on the sliding shaft seat portion 120 of the moving fitting seat 12 is displaced downward, passing through the set sliding hole 110 set on the fixed ring body 11, and pushing The external component 40 is magnetically attracted to the magnetic column 111A of the fixing hole 111 set in the fixed ring body 11, so that the external component 40 is separated from the driving hole 210A of the ratchet 210 set on the actuating end 21 of the ratchet wrench 20, providing the convenience of quick disassembly and removal, in order to achieve the effect of good functionality.

In summary, the present invention can indeed achieve the above-mentioned functions and purposes, so the present invention should meet the requirements of patent application and apply for it according to law.

1. A ratchet wrench and an external ratchet bushing anti-detachment and quick-release structure, comprising:
an anti-detachment quick-release assembly, wherein the anti-detachment quick-release assembly is provided with a fixed ring body, a movable fitting seat body and a threaded fitting cover body, the fixed ring body is provided with a number of sliding through holes at intervals, a fixed hole is respectively provided between the sliding piercing holes on the bottom side of the fixed ring body, a magnetic column is fixedly embedded in the fixed hole, the sliding shaft seat part and a set of seat parts, the bottom side of the sliding shaft seat part is provided with several sliding shafts at intervals, an inner fitting space is provided in the body of the threaded fitting cover body, the top side of the threaded fitting cover body is provided with a positioning fit ring flange, the sliding shaft set on the sliding shaft seat of the moving fit seat is displaceable and slides through the sliding holes set in the fixed ring body, and the fitting space inside the cover body and positioning fitting ring flange are relatively positioned fitting to the fitting seat provided by the moving fitting seat;
a ratchet wrench, wherein the ratchet wrench is provided with an actuating end, the actuating end is provided with a ratchet, and the ratchet is fixed with a C-shaped buckle, and the ratchet is provided with a driving hole, and the driving hole is provided with a ring near the top edge, the positioning and fixing part, the fixing ring body of the anti-detachment quick-release assembly is positioned and fixed on the ring positioning and fixing part of the ratchet wheel of the ratchet wrench; and
an external component, wherein the external component is accommodated in the driving hole of the ratchet provided on the working end of the ratchet wrench.

2. The ratchet wrench and an external ratchet bushing anti-detachment and quick-release structure as claim 1, wherein the outer side of the anti-detachment quick-release assembly is provided with anti-slip embossing on the outer side of the cover.

3. The ratchet wrench and an external ratchet bushing anti-detachment and quick-release structure as claim 1, wherein the magnetic column buried in the fixing hole of the fixing ring body of the anti-detachment quick release assembly is a powerful magnet column.

4. The ratchet wrench and an external ratchet bushing anti-detachment and quick-release structure as claim 1, wherein the external component is a ratchet bushing or a screw lock.

5. The ratchet wrench and an external ratchet bushing anti-detachment and quick-release structure as claim 1, wherein the thickness of the fixed ring body of the anti-detachment quick-release assembly is A, and the length of the sliding shaft of the moving fitting seat is B, and the length B of the sliding shaft is greater than the thickness A of the fixing ring body, so that the moving fitting seat body The number of sliding shafts can slide vertically through the holes set by the fixed ring without falling off.

6. The ratchet wrench and an external ratchet bushing anti-detachment and quick-release structure as claim 1, wherein the fixed ring body of the anti-detachment quick-release assembly is positioned and fixed on the ring positioning and fixing part of the ratchet wheel of the ratchet wrench. The external component is accommodated in the drive hole of the ratchet wheel at the actuating end of the ratchet wrench and pushes against the moving sleeve at the same time. The sliding shaft set on the sliding shaft seat of the seat body makes it move upward relative to the sliding hole set on the fixed ring body, and the fitting seat part of the moving fitting seat moves in the inner fitting space Finally, it is held against the flange of the positioning sleeve ring, and the external components are magnetically adsorbed and fixed by the magnetic column in the fixing hole of the fixing ring body of the anti-detachment quick-release assembly.

7. The ratchet wrench and an external ratchet bushing anti-detachment and quick-release structure as claim 1, wherein the fitting seat provided by the moving fitting seat of the anti-detachment quick-release assembly makes the fitting seat displace relative to the fitting space provided in the wearing fitting cover body, and at the same time makes the sliding shaft seat of the moving fitting seat The set number of sliding shafts moves downward, passes through the set number of sliding holes in the fixed ring body, and pushes against the magnetic column of the external component far away from the fixed hole set in the fixed ring body for magnetic adsorption, so that the external component is separated from the actuating end of the ratchet wrench The driving hole of the set ratchet.
